(19) United States
(12) Patent Application Publication
(10) Pub. No.: US 2021/0332500 A1
(43) Pub. Date: Oct. 28, 2021

(54) METHOD FOR MANUFACTURING POROUS ANTI-ADHESIVE FILM

(71) Applicant: NAN YA PLASTICS CORPORATION, TAIPEI (TW)

(72) Inventors: Te-Chao LIAO, Taipei (TW); Ching-Yao YUAN, Taipei (TW); Yu-Chi HSIEH, Taipei (TW); Min-Fan CHUNG, Taoyuan City (TW)

(21) Appl. No.: 17/238,343

(22) Filed: Apr. 23, 2021

(30) Foreign Application Priority Data
Apr. 24, 2020 (TW) 109113757

(51) Int. Cl. D01D 5/00; C08J 5/18; D04H 1/728

(52) U.S. Cl. CPC D01D 5/003; C08J 5/18; C08J 2389/06; C08J 2367/04; C08J 2367/02; D04H 1/728

(57) ABSTRACT

A method for manufacturing a porous anti-adhesive film is provided, which includes the steps of providing an electrospinning solution and performing an electrospinning process by using the electrospinning solution to form the porous anti-adhesive film The electrospinning solution includes a polymer material and a solvent. The solvent is selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether.

### CROSS-REFERENCE TO RELATED PATENT APPLICATION

This application claims the benefit of priority to Taiwan Patent Application No. 109113757, filed on Apr. 24, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for manufacturing an anti-adhesive film, and more particularly to a method for manufacturing a biomedical grade porous anti-adhesive film

### BACKGROUND OF THE DISCLOSURE

Among biodegradable polymer materials, synthetic materials such as polylactic acid (PLA) and polyglycolic acid (PGA) are usually used to be molded into porous structures, e.g., miniatures of sponges used in daily life, so as to allow cells to enter and adhere thereto.

Polylactic acid may be a poly-L-lactic acid (PLLA) or poly-D-lactic acid (PDLA), which has not only different solubilities but also different physical and chemical properties. For example, acetone can dissolve PDLA but cannot dissolve PLLA, just like tetrahydrofuran and N-methylpyrrolidone. In addition, dichloromethane and chloroform can each be used as a co-solvent for the dissolution of PLLA and PDLA.

Therefore, in conventional electrospinning processes, polymer materials, especially polylactic acid, are formed into nanofiber films by using dichloromethane and chloroform. However, dichloromethane and chloroform are each a toxic chemical substance. The nanofibers resulted from using dichloromethane and chloroform may have poor quality and large diameter differences, and are easy to form nodes and lead to a slow process speed. As a result, certain technical difficulties are still present when applying polymer materials, especially polylactic acid, in an electrospinning technology, particularly in endeavors to improve the anti-adhesive property of biomedical products.

In addition, since polylactic acid is not soluble in dimethylacetamide (DMAC), if the electrospinning technology uses polylactic acid as a polymer material to form an electrospinning solution, DMAC is required to be mixed with dichloromethane to form a polar solvent for electrospinning polylactic acid fibers. However, the electrospinning solution has a toxic chemical substance, such as methylene chloride, and cannot be applied as a biomedical-grade material.

Therefore, it has become an important issue in the relevant field to improve the design of a solvent formulation to increase the overall applicability of polymer materials in an electrospinning technology that is used to manufacture biomedical-grade materials such as a dressing, so as to overcome the above-mentioned inadequacies.

### SUMMARY OF THE DISCLOSURE

The present disclosure is seeks to address the issue of increasing the overall applicability of polymer materials in electrospinning technology. In response to the above-referenced technical inadequacies, a method for manufacturing a porous anti-adhesive film that improves upon the design of solvent formulation is provided in the present disclosure.

In one aspect, the present disclosure provides a method for manufacturing a porous anti-adhesive film, which includes the steps of providing an electrospinning solution and performing an electrospinning process by using the electrospinning solution to form the porous anti-adhesive film. The electrospinning solution includes a polymer material and a solvent. The solvent is selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether.

In one embodiment of the present disclosure, the solvent is present in an amount from 55% to 99% by weight of the total weight of the electrospinning solution.

In one embodiment of the present disclosure, the solvent is a mixture of one of acetone, butanone, ethylene glycol, hexafluoroisopropanol (HFIP), and isopropanol and one of deacetylated chitosan (DAC), N,N-dimethylformamide (DMF), dimethylacetamide (DMAC), dimethyl sulfoxide (DMSO), and ether, which are mixed in a weight ratio from 1:9 to 9:1.

In one embodiment of the present disclosure, the polymer material is present in an amount from 1% to 50% by weight of the total weight of the electrospinning solution.

In one embodiment of the present disclosure, the polymer material is selected from the group consisting of polylactic acid (PLA), polycaprolactone (PCL), poly(lactide-co-glycolide) (PLGA), polyhydroxyalkanoate (PHA), polyglycolic acid (PGA), hyaluronic acid and gelatin.

In one embodiment of the present disclosure, the porous anti-adhesive film has a thickness that is greater than 20 μm.

In one embodiment of the present disclosure, the electrospinning process is performed with conditions including a spinning temperature from 5° C. to 95° C. and a voltage intensity of 5 kV to 60 kV.

In one embodiment of the present disclosure, in the step of performing the electrospinning process by using the electrospinning solution, the porous anti-adhesive film is formed on a releasing film

In one embodiment of the present disclosure, a surface of the releasing film has an anti-adhesive effect and has silicon and fluorine components.

In one embodiment of the present disclosure, the releasing film has a thickness from 4 μm to 350 μm.

One of the beneficial effects of the present disclosure is that the method for manufacturing the porous anti-adhesive film can increase process stability and production speed, by virtue of “the solvent being selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether”. Therefore, the production efficiency is increased by at least 10 times.

Further, the manufacturing method of the present disclosure uses an electrospinning solution having a non-toxic (or low-toxic) formulation, the formulation does not include toxic solvents such as methylene chloride and chloroform, and uses a polymer material having biocompatibility and degradability such as polylactic acid. Therefore, the resulting porous anti-adhesive film can be applied to biomedical products, and does not give rise to harmful effects on human health and the environment.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a porous anti-adhesive film according to first and second embodiments of the present disclosure;

FIG. 2 is a schematic view showing an electrospinning device for implementing the method according to the first embodiment of the present disclosure;

FIG. 3 is a structural schematic view of the porous anti-adhesive film according to the first embodiment of the present disclosure;

FIG. 4 shows an enlarged view of section IV of FIG. 3;

FIG. 5 is a structural schematic view of the porous anti-adhesive film according to the second embodiment of the present disclosure; and

FIG. 6 is another structural schematic view of the porous anti-adhesive film according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

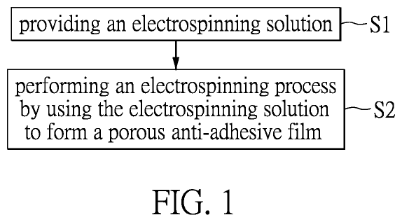

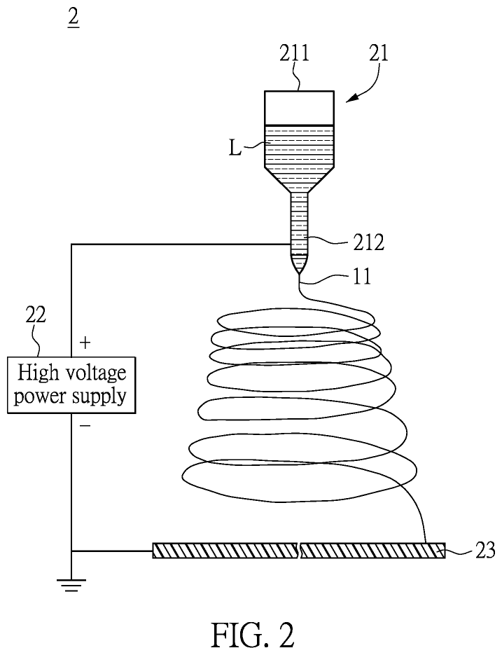

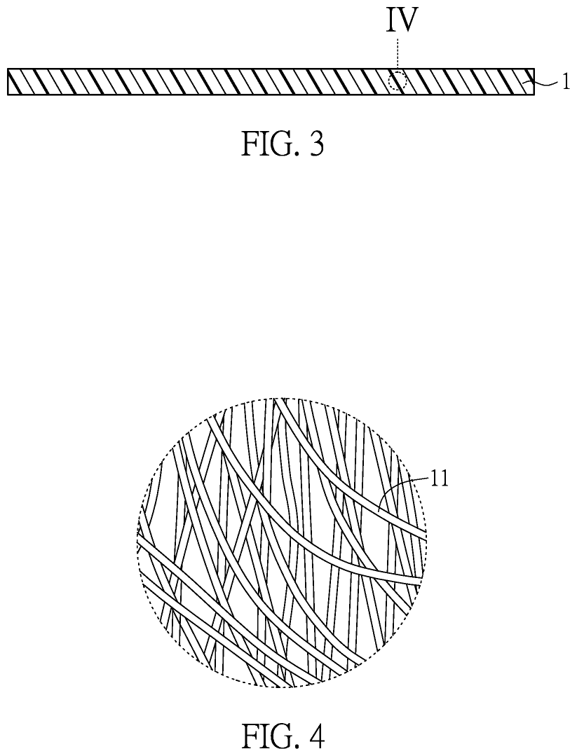

Referring to FIG. 1 to FIG. 4, a first embodiment of the present disclosure provides a method M for manufacturing a porous anti-adhesive film 1. The method M mainly includes: step S1, providing an electrospinning solution L; and step S2, performing an electrospinning process by using the electrospinning solution L to form the porous anti-adhesive film 1. The method M can be implemented by an electrospinning device 2 as shown in FIG. 2. FIG. 3 and FIG. 4 respectively show an overall structure and a partial structure of the porous anti-adhesive film 1 manufactured by using the method M of the present embodiment.

In the present embodiment, the electrospinning solution L uses a non-toxic (low-toxic) formulation, which mainly includes a polymer material and a solvent. The polymer material is present in an amount from 1% to 50% by weight of the total weight of the electrospinning solution L. The solvent is present in an amount from 55% to 99% by weight of the total weight of the electrospinning solution L. The polymer material is selected from the group consisting of polylactic acid (PLA), polycaprolactone (PCL), poly(lactide-co-glycolide) (PLGA), polyhydroxyalkanoate (PHA), polyglycolic acid (PGA), hyaluronic acid and gelatin, and preferably polylactic acid. The solvent is selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether. In consideration of the stability and quality of spinning fibers, the solvent is preferably a mixture of acetone and DMAC that are mixed in a weight ratio from 1:9 to 9:1. In certain embodiments, if necessary, the electrospinning solution L may include other components such as a tackifier.

As shown in FIG. 2, the electrospinning device 2 mainly includes a spinning device 21, a high voltage power supply 22 and a collecting board 23. The spinning device 21 includes a liquid storage tank 211 and a spinning nozzle 212. The spinning nozzle 212 is in fluid communication with the bottom of the liquid storage tank 211. The high voltage power supply 22 has positive and negative outputs that are respectively and electrically connected to the spinning nozzle 212 and the collecting board 23. In use, the electrospinning solution L is placed in the liquid storage tank 211, and an electric field with a predetermined intensity is then generated between the spinning device 21 and the collecting board 23 by the high voltage power supply 22. Accordingly, the electrospinning solution L is ejected from the spinning nozzle 212, and is formed into one or more polymer fibers 11 to be deposited on the collecting board 23. The one or more polymer fibers 11 can be closely stacked, wound or interlaced in specific directions by controlling the movement of the spinning device 21 to form a porous anti-adhesive film 1 having a uniform thickness.

More specifically, the porous anti-adhesive film 1 is formed by one or more polymer fibers 11. In order to meet particular requirements, the diameter of each of the polymer fibers 11 can be from 1 nm to 10000 nm, and the thickness of the porous anti-adhesive film 1 is preferably greater than 200 μm. In certain embodiments, the porous anti-adhesive film 1 can contain substances that are beneficial to promote wound healing, such as antibiotics and growth factors. However, these details regarding the porous anti-adhesive film 1 are merely exemplary, and are not intended to limit the present disclosure.

In step S2, the porous anti-adhesive film 1 can reach a desired quality by setting control parameters of the electrospinning process, in which the diameter difference between the polymer fibers 11 is small and nodes are not easily formed. The control parameters of the electrospinning process include a concentration and an ejection speed of electrospinning solution L, a spinning temperature, intensity of electric field, a collection distance (also called “deposition distance”), and a collection time. In the present embodiment, the spinning temperature can be from 5° C. to 95° C., and preferably from 10° C. to 90° C. The intensity of electric field can be from 5 kV to 60 kV, and preferably from 10 kV to 25 kV. The ejection speed of the electrospinning solution L can be from 0.1 cc/min to 5 cc/min. The collection distance is between the spinning nozzle 212 and the collecting board 23, and it can be from 15 cm to 90 cm. However, these details regarding the electrospinning process are merely exemplary, and are not intended to limit the present disclosure.

### Second Embodiment

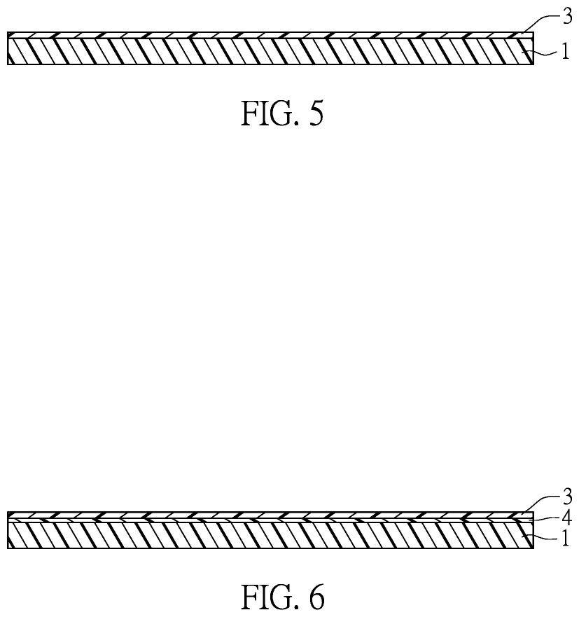

Referring to FIG. 1 and FIG. 2, which is to be read in conjunction with FIG. 5 and FIG. 6, a second embodiment of the present disclosure provides a method M for manufacturing a porous anti-adhesive film 1. The method M mainly includes: step S1, providing an electrospinning solution L; and step S2, performing an electrospinning process by using the electrospinning solution L to form the porous anti-adhesive film 1. The main difference between the first and second embodiments is that, in the step S2, the electrospinning process is performed after a releasing film 3 is placed on the collecting board 23. Accordingly, one or more polymer fibers 11 are deposited on the collecting board 23, and a porous anti-adhesive film 1 having a uniform thickness is thus formed on the releasing film 3 It should be noted that, in the presence of the releasing film 3, the porous anti-adhesive film 1 can be easily peeled off from the collecting board 23 so as to maintain structural integrity. That is, the porous anti-adhesive film 1 can be completely peeled off from the collecting board 23.

In the present embodiment, the electrospinning solution L uses a non-toxic (low-toxic) formulation, which mainly includes a polymer material and a solvent. The polymer material is present in an amount from 1% to 50% by weight of the total weight of the electrospinning solution L. The solvent is present in an amount from 55% to 99% by weight of the total weight of the electrospinning solution L. The polymer material is selected from the group consisting of polylactic acid (PLA), polycaprolactone (PCL), poly(lactide-co-glycolide) (PLGA), polyhydroxyalkanoate (PHA), polyglycolic acid (PGA), hyaluronic acid and gelatin, and preferably polylactic acid. The solvent is selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether. For example, the solvent is a mixture of one of acetone, butanone, ethylene glycol, hexafluoroisopropanol (HFIP), and isopropanol and one of deacetylated chitosan (DAC), N,N-dimethylformamide (DMF), dimethylacetamide (DMAC), dimethyl sulfoxide (DMSO), and ether, which are mixed in a weight ratio from 1:9 to 9:1. In consideration of the stability and quality of the spinning fibers, the solvent is preferably a mixture of acetone and DMAC that are mixed in a weight ratio from 1:9 to 9:1.

As shown in FIG. 5, the porous anti-adhesive film 1 manufactured by the method M of the present embodiment has a releasing film 3 provided on a surface thereof The releasing film 3 can prevent the porous anti-adhesive film 1 from coming in contact with dirt before being used (e.g., covered on a wound). The thickness of the releasing film 3 can be from 4 μm to 350 μm, preferably from 9 μm to 100 μm, but it is not limited thereto. The material of the releasing film 3 is not particularly limited insofar as the releasing film 3 can carry the porous anti-adhesive film 1 and is stably attached to the surface of the porous anti-adhesive film 1.

As shown in FIG. 6, according to particular requirements, a silicon coating layer can be formed on the releasing film 3. Accordingly, when the electrospinning process is performed, one or more polymer fibers 11 are deposited on the silicon coating layer, and a porous anti-adhesive film 1 having a uniform thickness is thus formed on the silicon coating layer. The advantage of this is that, when the releasing film 3 is removed, the porous anti-adhesive film 1 can be prevented from being damaged on structural integrity.

### [Beneficial Effects of the Embodiments]

One of the beneficial effects of the present disclosure is that the method for manufacturing the porous anti-adhesive film can increase process stability and production speed, by virtue of “the solvent being selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether”. Therefore, the production efficiency is increased by at least 10 times.

Further, the manufacturing method of the present disclosure uses an electrospinning solution with a non-toxic (low-toxic) formulation, which does not include toxic solvents such as methylene chloride and chloroform, and uses a polymer material having biocompatibility and degradability such as polylactic acid. Therefore, the resulting porous anti-adhesive film can be applied to biomedical products, and does not give rise to harmful effects on human health and the environment.

It is worth mentioning that, the manufacturing method of the present disclosure can improve the physical, chemical, biological, mechanical and other properties of spinning fibers. Accordingly, the resulting porous anti-adhesive film has a flexible and stable overall structure, and has not only a certain degree of structural strength but also high porosity and a high area to volume ratio. As a result, the resulting porous anti-adhesive film can provide a good environment for cell growth and support the growth of new tissues, thereby reducing wound healing time and being suitable for use as a wound dressing.

Furthermore, the manufacturing method of the present disclosure can allow one or more polymer fibers to be closely stacked, wound or interlaced in specific directions, so as to provide a balance between structural strength and porosity. Accordingly, the resulting porous anti-adhesive film can create an environment that is similar to an extracellular matrix of an organism to facilitate cell adhesion and proliferation.

In addition, the manufacturing method of the present disclosure can use degradable polymer materials. Therefore, the resulting film structure will gradually disintegrate during a period of use, allowing the gradual regeneration and repair of damaged biological tissues.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a porous anti-adhesive film, comprising:
providing an electrospinning solution that includes a polymer material and a solvent, wherein the solvent is selected from the group consisting of acetone, butanone, ethylene glycol, hexafluoroisopropanol (HFIP), isopropanol, deacetylated chitosan (DAC), N,N-dimethylformamide (DMF), dimethylacetamide (DMAC), dimethyl sulfoxide (DMSO), and ether; and
performing an electrospinning process by using the electrospinning solution to form the porous anti-adhesive film.

2. The method according to claim 1, wherein the solvent is present in an amount from 55% to 99% by weight of the total weight of the electrospinning solution.

3. The method according to claim 2, wherein the solvent is a mixture of one of acetone, butanone, ethylene glycol, hexafluoroisopropanol (HFIP), and isopropanol and one of deacetylated chitosan (DAC), N,N-dimethylformamide (DMF), dimethylacetamide (DMAC), dimethyl sulfoxide (DMSO), and ether, which are mixed in a weight ratio from 1:9 to 9:1.

4. The method according to claim 1, wherein the polymer material is present in an amount from 1% to 50% by weight of the total weight of the electrospinning solution.

5. The method according to claim 4, wherein the polymer material is selected from the group consisting of polylactic acid (PLA), polycaprolactone (PCL), poly(lactide-co-glycolide) (PLGA), polyhydroxyalkanoate (PHA), polyglycolic acid (PGA), hyaluronic acid and gelatin.

6. The method according to claim 1, wherein the porous anti-adhesive film has a thickness that is greater than 20 μm.

7. The method according to claim 1, wherein the electrospinning process is performed with conditions including a spinning temperature from 5° C. to 95° C. and a voltage intensity of 5 kV to 60 kV.

8. The method according to claim 1, wherein, in the step of performing the electrospinning process by using the electrospinning solution, the porous anti-adhesive film is formed on a releasing film.

9. The method according to claim 8, wherein a surface of the releasing film has an anti-adhesive effect and has silicon and fluorine components.

10. The method according to claim 9, wherein the releasing film has a thickness from 4 μm to 350 μm.
